(19) United States
(12) Patent Application Publication
(10) Pub. No.: US 2018/0211775 A1
(43) Pub. Date: Jul. 26, 2018

(54) MULTI-LAYER ELECTROMAGNET STRUCTURE AND MANUFACTURING PROCESS

(71) Applicant: Apple Inc., Cupertino, CA (US)

(72) Inventors: Alexander V. Salvatti, Morgan Hill, CA (US); Bonnie W. Tom, San Leandro, CA (US)

(21) Appl. No.: 15/878,229

(22) Filed: Jan. 23, 2018

Related U.S. Application Data
(60) Provisional application No. 62/450,016, filed on Jan. 24, 2017.

(51) Int. Cl. H01F 41/04; H01F 7/06; H01F 27/28; H01F 27/29; H01F 41/12; H01F 27/32; H04R 9/04

(52) U.S. Cl. CPC H01F 41/041; H01F 7/06; H01F 27/2804; H01F 2027/2809; H01F 41/12; H01F 27/323; H04R 9/046; H01F 27/29

(57) ABSTRACT

A multilayer circuit structure has a number of electrically conductive trace layers, separated from each other by a number of electrically insulating layers. The thickness of any given one of the conductive trace layers is greater than the thickness of its adjacent one of the insulating layers. Also, each of the conductive trace layers is bonded to an adjacent one of the insulating layers, and is electrically joined to an adjacent one of the conductive trace layers through a gap in the adjacent one of the insulator layers that is between them. Other aspects are also described and claimed.

This non-provisional patent application claims the benefit of the earlier filing date of U.S. provisional application No. 62/450,016 filed Jan. 24, 2017.

### FIELD

An aspect of the disclosure here is a voice coil for use in consumer electronics acoustic transducers such as micro-speakers, that has a greater conductor packing factor than a round wire wound coil and that is suitable for high volume manufacture. Other aspects are also described and claimed.

### BACKGROUND

Micro-speakers are often designed to have a rectangular shape rather than a round shape, to achieve better space utilization in the restricted spaces where such transducers are placed. Also, to improve acoustic performance, an edge wound coil design typically yields a higher packing factor for the windings of the speaker's voice coil (increased density of turns), as compared to other coil wire and winding designs. It is difficult however to wind an edge wound coil into a shape that is not circular.

### SUMMARY

An aspect of the disclosure here is a coil structure whose appearance and packing factor are similar to those of an edge wound flat wire coil but that may be less costly to produce and may exhibit greater flexibility in terms of the shape or profile (or envelope) of the width of the turns of the structure. The coil structure has some similarities to a Bitter electromagnet in that it has a number of turns where each turn has a respective, flat annular conductor and a respective flat annular insulator. The turns are stacked (or form a stack) so that the flat annular conductors are interleaved with the flat annular insulators, and are aligned so that a central opening extends vertically through all of the conductors and insulators. The top face of the respective flat annular insulator of each turn forms a bond with the bottom face of the respective conductor of the turn that is immediately above it, while the bottom face of the respective annular conductor of each turn is electrically joined to the top face of the respective annular conductor of the turn that is immediately below it. That electrical joint is made through a gap that has been formed in the respective annular insulator of the turn below.

Note here that in contrast to the Bitter electromagnet which is generally built as an interleaved stack of metal and insulating plates held together via bolts to press all the layers together, an aspect of the disclosure is that there is no need for an external fastener to keep the conductors and insulators pressed against each other, and also no liquid cooling holes are needed to cool the structure. These are at least in part due to the lower levels of electrical current that will be running through the coil structure, particularly when used as part of a consumer electronics transducer motor that generates a Lorentz force, such as a microspeaker driver or other acoustic transducer that may for example have a diaphragm diameter (or length) of less than six inches and more specifically less than two inches, and even more specifically less than one inch. The coil structure may also be used (to generate the Lorentz force) as part of an electro-mechanical actuator, or it may be used as a voltage generator to generate a voltage at its terminals in response to an external force being applied to move the coil structure such as in an acoustic microphone. Other consumer electronics applications of the coil structure include haptic vibrators, tactile exciters or shakers, inductive sensing, and inductive charging.

A method for manufacturing a coil structure is as follows. A number of sheets are arranged into a stack, where each sheet has a laminated region in which a respective, flat conductor and a respective flat insulator are formed. A respective conductor gap is formed that extends inward from an outer perimeter of the conductor and from a bottom face to a top face of the conductor. In addition, a respective insulator gap is formed that extends from a bottom face to a top face of the insulator. The flat conductors are thus interleaved (or alternated) with the flat insulators (to form the stack). In one aspect, the stack of sheets has been formed in this manner, a top and a bottom of the stack are pressed towards each other while heating the stack until the respective flat insulator of each sheet melts or softens and exhibits adhesive properties to form a bond with the bottom face of the respective flat conductor that is in the sheet immediately above it. Alternatively, the adhesive property and the insulating property could be provided by separate materials. Also, the bottom face of the respective conductor in each sheet forms an electrical joint with the top face of the respective conductor in the sheet that is immediately below it, through the insulator gap that is between the two respective conductors. Once the stack has been fused in this manner, a separate annular structure is cut from the stack, by cutting through the stack along a predetermined outer perimeter and along a predetermined inner perimeter in the laminated region, and the portion between the inner and outer perimeters is kept as the final coil structure. Other differences between such a manufacturing process and one used to fabricate flexible printed circuits (FPCs) are a greater quantity of stacked layers, greater precision desired for layer alignment, and a desire to minimize the thickness of the insulating layers.

The manufacturing process advantageously allows for a variety of different, annular shapes to be produced, including round, rectangular, square, triangular, semicircular, serpentine zig zag, or any combination of such shapes. Also, such a process is efficient in terms of reduced materials waste, particularly as the size or diameter (length) of the coil (annular electromagnet structure) becomes smaller. An additional benefit is that some of the turns of the coil can be made to have a narrower annular width than others of the coil; in other cases, there may be some layers in the structure that have no conductor in them. The process allows the conductors to be placed in any selected turn, for example at a desired height or position of the stack; this feature enables the force versus excursion characteristic of the resulting motor structure, such as in an acoustic transducer or an electro-mechanical actuator for example, to be tailored to the particular application. In addition, no former is needed to manufacture the electromagnet structure using the above process, which allows the magnetic gap (air gap), in the magnet system of an acoustic output transducer, within which the coil structure is suspended to be made smaller, for greater magnetic efficiency. An additional benefit of this method is that, as any coil shape which can be described as a 2D shape may be cut out from the finished laminated stack, unique coil shapes which are not possible to realize in wire-wound coils may be easily created which allows the design of transducer shapes which hitherto have been considered impractical. For example, it is not practical to make a wire wound coil that has sharp corners, as it would kink the wire and cause a stress concentration, which would weaken it. A further benefit from making a coil with this technique is that the width of the conductor chosen for the coil does not impact the manufacturability of the part, as opposed to a wire wound coil where a wire can only physically be flattened by a certain amount before it becomes impractical to wind on edge. For example, typical wire flattening is difficult to exceed a ratio of 15:1 (where the width of the wire exceeds about 15 times the height). This limits the design freedom. With the present method, virtually any conductor aspect ratio is possible, for example 100:1 or more is possible.

Another aspect of the disclosure here is a method for manufacturing a multilayer coil structure using printed circuit fabrication techniques, where each conductor 2 (see FIGS. 8-12) is formed in a respective, printed circuit conductive trace layer that is electrically insulated from an adjacent conductive trace layer by a dielectric layer (insulator 4). A printed circuit laminate is thereby formed whose metal layers have been patterned into the shapes of the conductors 2 (e.g., as shown in FIG. 10.) Now, to achieve the needed electrical joint between each pair of adjacent conductors (which results in a single, multiturn coil being formed), a separate conductive structure (separate from the pair of adjacent conductors) referred to generally here as a bridge region may be formed; when using printed circuit fabrication techniques, the bridge region may be a via (a plated via, such as a plated through hole via, a blind via, or a buried via) or a plug made of a conductive material.

The above summary does not include an exhaustive list of all aspects of the present invention. It is contemplated that the invention includes all systems and methods that can be practiced from all suitable combinations of the various aspects summarized above, as well as those disclosed in the Detailed Description below and particularly pointed out in the claims filed with the application. Such combinations have particular advantages not specifically recited in the above summary.

### BRIEF DESCRIPTION OF THE DRAWINGS

The aspects of the disclosure here are illustrated by way of example and not by way of limitation in the figures of the accompanying drawings in which like references indicate similar elements. It should be noted that references to “an” or “one” aspect in this disclosure are not necessarily to the same aspect, and they mean at least one. Also, in the interest of conciseness and reducing the total number of figures, a given figure may be used to illustrate the features of more than one aspect, and not all elements in the figure may be required for a given aspect.

FIG. 1 illustrates several cross-section views of conventional voice coil designs.

FIG. 2a is an exploded view of an example stack of conductor and insulator layers as part of coil structure.

FIG. 2b is an exploded view of another aspect of an electromagnet structure, which includes a conductive bridge region between adjacent conductors, which is placed in the gap that is left in the insulating layer that is between the conductors.

FIG. 3 is a section view of an aspect of the coil structure, showing the path of current through adjacent turns.

FIG. 4 illustrates part of a manufacturing process for producing an example coil structure.

FIG. 5 depicts an example of the multi-layer or laminated sheets in which replicates of each laminated region that results in a turn, have been produced, prior to the sheets being arranged into a stack.

FIG. 6 shows the how the sheets can be cut, to form the desired final annular shape of the coil structure

FIG. 7 illustrates a uniform width, edge-wound ribbon coil next to a shaped width or profiled, coil structure.

FIG. 8 shows an example of the bottom, middle and top conductive layers of the coil structure.

FIG. 9 illustrates an aspect where a diaphragm for an acoustic transducer may be integrated into a top turn of the coil structure.

FIG. 10 shows an example of how an acoustic transducer's suspension may be integrated into the top layer of a coil structure.

FIG. 11 illustrates an alternative termination scenario for the coil structure.

FIG. 12 illustrates another example of the coil structure in which each conductor or each turn forms a spiral.

### DETAILED DESCRIPTION

Several aspects with reference to the appended drawings are now explained. Whenever the shapes, relative positions or other aspects of the parts described in this disclosure are not explicitly defined, the scope of the invention is not limited only to the parts shown, which are meant merely for the purpose of illustration. Also, while numerous details are set forth, it is understood that some aspects may be practiced without these details. In other instances, well-known circuits, structures, and techniques have not been shown in detail so as not to obscure the understanding of this description.

The term “adjacent” is used here to refer to the next closest such element, in a given sequence. The terms “top” and “bottom” are broadly used to only distinguish one end of a structure from another, and do not imply any particular orientation to the structure. Similarly, the terms “below” and “above” are used in a relative sense to indicate opposing directions, e.g., B is below A and above C, but do not imply any particular orientation to the structure as a whole (in connection with which they are used.)

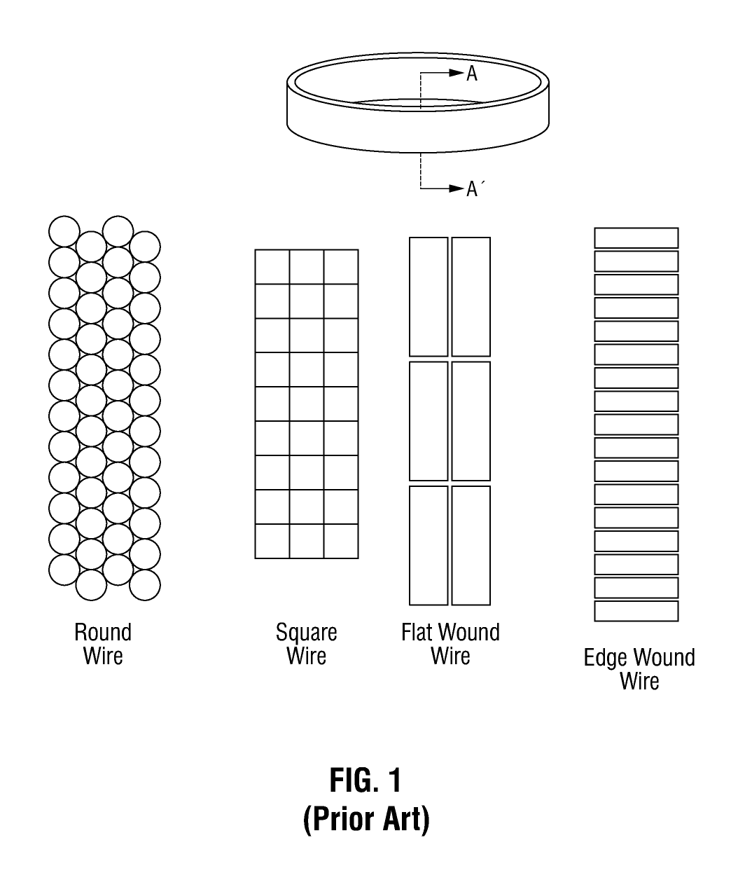

In a conventional voice coil, a length of insulated wire is wound around a former or mandrel having a center axis, to form multiple loops or turns about the center axis. FIG. 1 shows cross section views of several such voice coils, including one that uses a round wire, and another that uses a square wire. The latter results in a higher space utilization of the conductive material within the total maximum dimensions of the winding cross section. This space utilization is referred to as a “packing factor”. Packing factor for typical wire wound coils tends to be in the range of 40-60% depending on several design and manufacturing variables including the size of the wire, size of the coil, type and thickness of the insulation layer, winding tension, and other factors. Another type of voice coil that is shown has a flat wound wire coil, where the insulated wire has been flattened before being wound several times along its flat face, against the former or winding mandrel (only the wire is shown in the cross section views). A more costly but higher performing voice coil design (having greater efficiency, in terms of greater packing factor) is the edge wound version shown, in which the flattened wire is looped around the former or winding mandrel, while lying on its edge rather than on its flat face. The edge wound wire coil may have the highest performance of the versions shown. It is however difficult to wind especially at high curvature (or smaller coil diameter), which is needed for use in micro-speakers such as those that have a coil diameter of less than two inches, for example. The difficulty of winding an edge wound wire coil may be due to a number of factors, including the ratio of the wire radial width (before being flattened) to the radius of curvature of the winding, how much pressure is applied during the winding process to keep the turns properly on edge, the type of wire being used, and other factors. It is also difficult to wind an edge wound coil into a shape that is not circular. Micro-speakers, in particular, are often designed to have a rectangular shape rather than a round shape, to achieve better space utilization in the restricted spaces where such transducers are placed. A higher performance transducer may be designed when the shape of its voice coil is not restricted to round shapes.

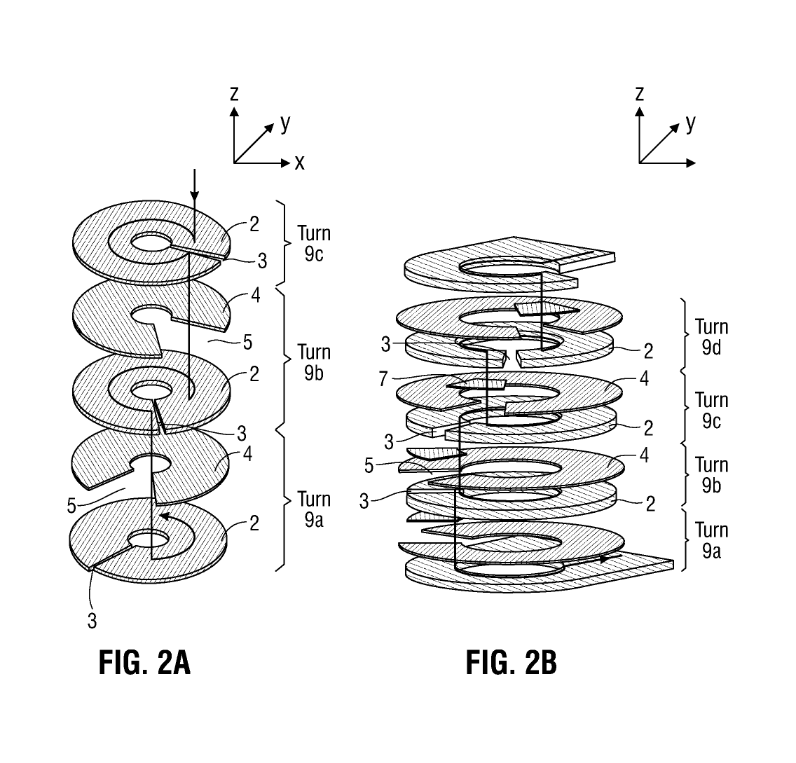

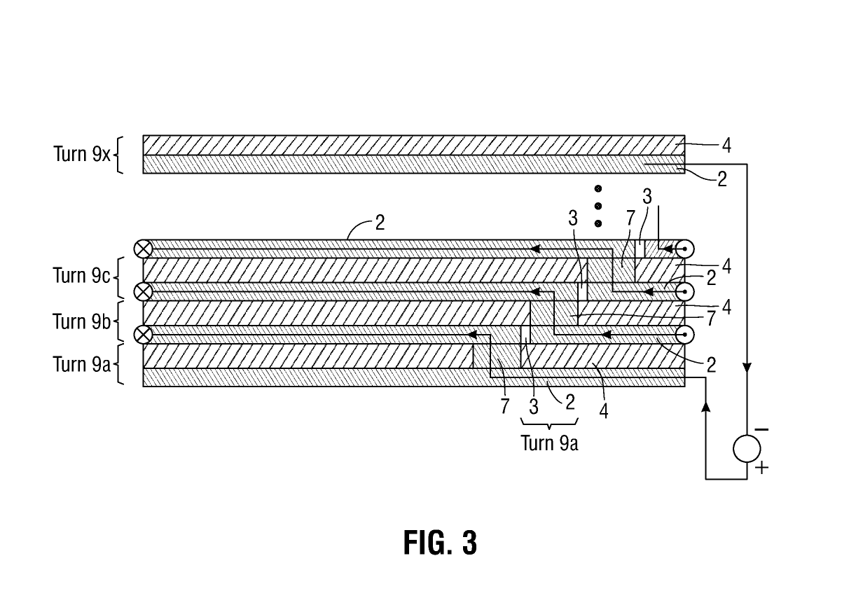

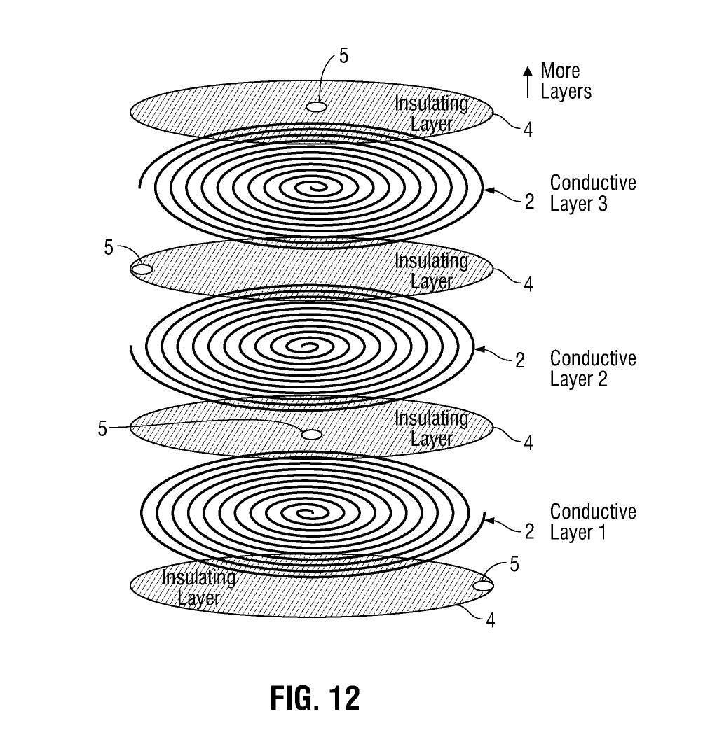

FIG. 2a is an exploded view of an example stack of conductor and insulator layers, that form a multilayer circuit structure, and in particular an electromagnet structure (also referred to here as a coil.) The coil may be viewed as having a number of turns. Each turn includes a respective, electrical conductor 2 (also referred to here as a conductive trace layers, electrical layers, or conductive layers) in which a respective conductor gap 3 is formed that extends from an outer perimeter to an inner perimeter of the conductor 2, and from a bottom face to a top face of the conductor 2. Each turn also includes a respective, electrical insulator 4 (also referred to here as an electrically insulating layer) in which a respective insulator gap 5 is formed that extends from a bottom face to a top face of the insulator 4. Unless otherwise specified, any layer (e.g., the insulator 4, the conductor 2) in this disclosure may be composed of multiple sub-layers (e.g., a laminate of several layers of different materials), or it may be a single layer of a single material, that can perform the desired function of that layer (e.g., insulating a pair of adjacent conductors 2 from each other, conducting electrical current.) The bottom face of the respective insulator 4 may be joined to the top face of the respective conductor 2, e.g., bonded as a pre-laminated structure. The turns are stacked or form a stack as shown in for example FIG. 3, so that a number of conductors 2 are interleaved (or alternated) with a number of insulators 4. In addition, in this particular aspect, and as shown, the conductors 2 and insulators 4 are aligned so that a central opening extends vertically through all of the conductors and insulators. Contrast this design with that of FIG. 12 described further below, which does not have such a central opening.

In addition, the top face of the respective insulator 4 of each turn forms a joint with the bottom face of the respective conductor 2 of the turn that is immediately above it, and the bottom face of the respective conductor 2 of each turn is electrically joined to the top face of the respective conductor 2 of the turn that is immediately below it, through the insulator gap 5 in the respective insulator 4 of the turn below. In one aspect, if there is sufficient adhesion between the insulating layers to ensure that the adjacent conductive layers are in intimate contact, the electrical connection or electrical joint between adjacent conductive layers may be created by simply overlapping the two conductive layers in the region of the insulator gap 5, without the use of any additional means to make the electrical connection. The intimacy of the contact can be adjusted by selecting the appropriate amount of overlapping area (a range of less than 15% of the total layer area may be typically selected as a suitable overlap area); lower values may be unable to ensure a low resistance connection, while excessively high overlap areas reduce the effective current flow path leading to undesirable axial current flow rather than the desired circulating or loop current flow and reduce the effective number of turns available to contribute to the overall conductor length.

In one aspect, each of the insulators in a stack is a layer (that may have one or more constituent sub layers) of uniform thickness in a z direction and across an x-y plane, and the insulators may all have the same thickness; similarly, each of the conductors in the stack is a layer (that may have one or more constituent sub layers), of uniform thickness in the z direction and across an x-y plane, and the conductors may all have the same thickness. For example, the thickness of the insulator 4 may be less than 15 microns, or it may be in the range of 3-5 microns, or 1-3 microns, or as thin as possible while still being able to insulate against electrical current from its two adjacent conductors 2 punching through. In contrast, the conductor 2 may have a thickness of 5-50 microns, the particular conductor thickness being dictated by the necessities of the design, current flow, resistance target, etc. For coil applications, it may be desirable to minimize the amount of insulator and maximize the relative amount of conductor present.

In another aspect, the coil structure is a multi-layer circuit in which the thickness of any given one of the conductive trace layers (conductors 2) is greater than the thickness of an adjacent one of the insulating layers (insulators 4). The thickness of each of the insulating layers may be less than 500 microns, and more particularly less than 20 microns, while each of the conductive trace layers is thicker than any of the insulating layers.

In another aspect, referring now to FIG. 2b, there is a respective, conductive bridge region 7 formed on the top face of an otherwise flat, conductor 2, in each turn. The respective bridge region 7 may be joined to the top face of the conductor 2, e.g., as a separately formed piece as shown, or by plating or tinning that section of the top face of the conductor 2 with a suitable metal, such as gold or nickel or a solder material or conductive paste, which is aligned with the gap 5 in the insulator 4, to a thickness that is of the same order of magnitude as the thickness of the insulator 4. The bridge region 7 may also be a plug made of a conductive material, such as a region of conductive microspheres (generally spherical particles made of glass or other insulator that are metalized, or metal), or an amount of solder paste that has been applied into the insulator gap 5 which sticks to the exposed portion of the top face of the conductor 2. In such instances, the bridge region 7 could melt or reflow when heated (e.g., during the heating and pressing stage described below) to form not only a mechanical joint but especially a lower resistance electrical joint between the conductor 2 of its turn and the conductor 2 of the turn that is immediately above it.

The bridge region 7 is aligned with the insulator gap 5 that is formed in the respective insulator 4 of the same turn, so that it is exposed by that gap 5. The bottom face of the respective conductor 2 of a turn is electrically joined to the respective conductor 2 of the turn that is immediately below it, as shown, through the respective bridge region 7. The bridge region 7 may thus serve to fill the thickness of the insulator 4 (of its turn), to better ensure electrical contact between the conductor 2 of its turn and the conductor 2 of the turn that is immediately above it. In another aspect, when using printed circuit fabrication techniques, the bridge region 7 may be a via, e.g., a through hole via, a blind via, or a buried via.

The examples of the conductors 2 and insulators 4 shown in FIGS. 2a, 2b are annular, and circular. However, they need not be circular. These are generally annular or ring-like, and form a loop, but not necessarily a closed loop. The conductor 2 is not a closed loop, because it has the conductor gap 3 formed therein that extends from the outer perimeter to the inner perimeter of the disk-like shape of the conductor 2. Similarly, the disk-like shape of the insulator 4 is an open curve, not a closed curve, due to the insulator gap 5 that also extends from an outer perimeter to an inner perimeter of the insulator 4. Note however that the insulator gap 5 could alternatively be sized and positioned entirely within the annular width, so as not to extend to either the inner or the outer perimeter of the insulator 4, e.g. as a drilled hole. As explained above, the insulator gap 5 serves to enable the two adjacent conductors 2 to become electrically joined to each other in the vertical direction.

Also as suggested above and described further below, the shape of the completed, coil structure is generally deemed to be a closed curve, such as a circle, an ellipse, a rectangle, or a square. In the examples shown in the subsequent figures described below, the shape of the completed coil structure is a rectangle. More generally, the annular shape of the completed coil may be a closed curve that has an arbitrary shape, may contain straight or curved portions or a combination thereof, and where the empty, central opening of the annular shape may serve to reduce the weight of the coil, which is advantageous in certain transducer and actuator applications.

Furthermore, in some aspects, the adhesive and insulating properties of the insulator 4 (see, e.g., FIG. 2B where the insulator 4 is shown as a single object in the drawing) may be provided by separate materials, such as a laminate of two materials.

Turning now to FIG. 3, this is a section view of an aspect of the coil structure of FIG. 2a, showing the path of current through a sequence of turns. The current loops in the same direction (here, counter clockwise as viewed downward from the top) as it flows through turn 9a, to turn 9b, to turn 9c, etc. Note that this direction of current is reversed relative to that shown in FIGS. 2a, 2b (due to the polarity reversal in the particular electrical source depicted in FIG. 3.) Also, note how a position of the respective conductor gap 3, in a given turn 9a, as reflected onto a horizontal plane along a vertical axis that runs through the respective conductor gap 3, is offset relative to the position of the respective conductor gap 3 in an adjacent turn 9b. This feature allows each electrical joint, between adjacent turns (here, turns 9a, 9b through the added, conductive bridge region 7), to be created as a vertical path that does not overlap with an adjacent electrical joint that connects the next pair of adjacent turns, as seen in FIG. 3.

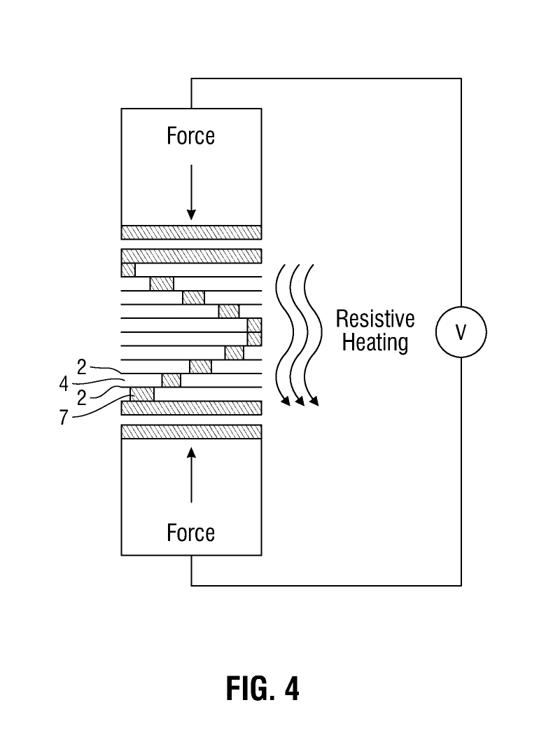

Turning now to FIG. 4, this figure illustrates a heated press stage, during an example manufacturing process, for producing an aspect of the electromagnet structure. The figure depicts how a single coil can be made by pressing a stack of its constituent turns together while heating. The heat may be applied externally via for example, cartridge heaters in the press platen, or via heated air, or an oil bath. Alternatively, the heat may be generated via resistive heating, aka. Joule heating, which causes heat to be generated internally within the conductors 2, a process which would favorably apply the heat directly where it is needed to create a reliable bonding of the layers. Note that although the application of heat is described, it may not be required to apply heat in order to join (e.g., bond) the layers together, depending on the technique or material being used to supply the adhesion function between an insulating layer and the adjacent conductive layers (e.g., pressure sensitive adhesive, moisture activated bonding, ultrasonic emission, or RF energy activation.) For example, the insulating layer may be made of a PSA (pressure sensitive adhesive), which only requires pressure to activate. The remainder of this disclosure will assume however a heat based assembly method.

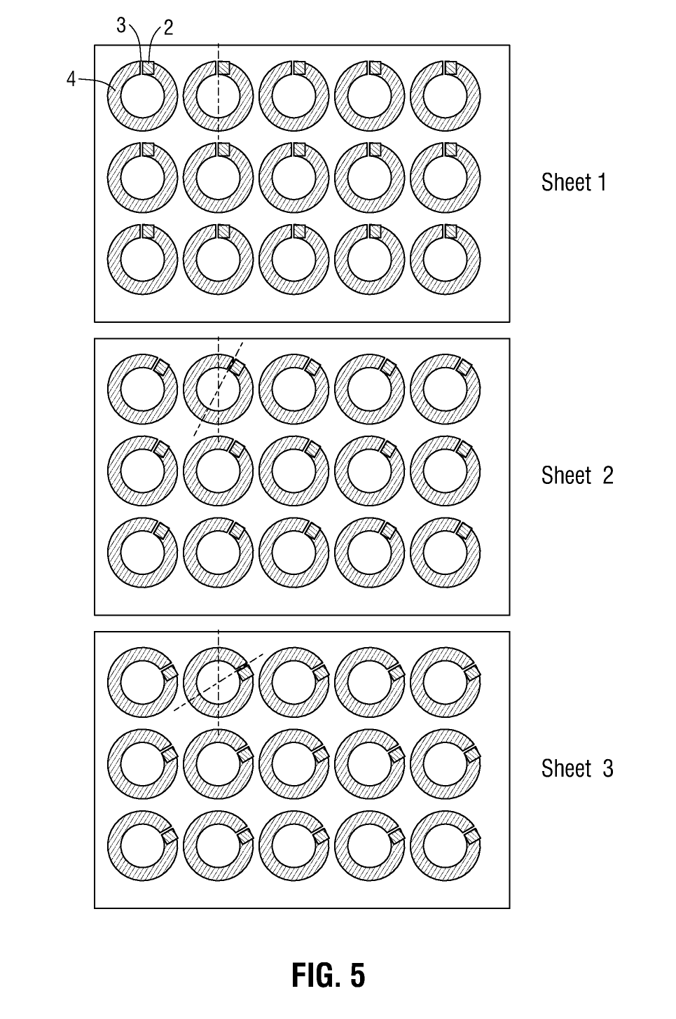

The pressing operation may be repeated simultaneously to make a number of coils at the same time, as follows. The process may begin with producing a number of sheets. As seen in FIG. 5, each sheet may be made to have a number of laminated regions each being composed of, for example, an insulating layer and a conducting layer, where each laminated region will become a turn of a separate coil. In other words, a particular turn can be created for many coils simultaneously, as a sheet of laminated regions. Thus, in FIG. 5, sheet 1 contains fifteen laminated regions that will result in fifteen instances of turn 9a, respectively; sheet 2 contains fifteen laminated regions that will result in fifteen instances of turn 9b; sheet 3 contains fifteen laminated regions that will result in fifteen instances of turn 9c; etc. Each sheet thus has formed therein a number of laminated regions that are replicates. In addition, in this particular aspect, the laminated region that results in turn 9b is an offset version (rotated by a given offset angle) of the laminated region for turn 9a; similarly, the laminated region for turn 9c is the same as that of turn 9b but offset (by the same, or different, offset angle or the same, or different linear offset); and so on.

In another aspect, the process would not rely on sheets which are pre-laminated conductor and insulator groupings, but rather would use separate conductor sheets and insulator sheets, which parts would be interleaved, registered for alignment, and assembled as described above.

In yet another aspect, a sheet, as in FIG. 5, is formed by applying a thin, electrically insulating coating in a liquid state onto the conductor 2, and then enabling the coating to harden to form the insulator 4 as a durable, insulating film on the conductor 2. This aspect of forming the insulator 4 starting as a thin coating in a liquid state, as compared to dry film that may have a thickness as high as 4-5 microns, reduces the thickness of the insulator 4 and therefore improves the packing factor and may also improve manufacturability. A 2-stage process may be performed to coat the conductor 2, where an inner layer or base coating is applied to the conductor 2 that is considered to be a hard insulating layer, and then an outer layer or bond coating is applied on top of the base coating. The base coating may be described as a “thin” coating, which may have a thickness in the range of one micron+/−20%. The material of the base coating may be based on polyurethane, modified polyurethane, polyesterimide, polyamidimide, polyimide, or polyamide (which are listed in order of increasing temperature capability.)

The bond coating is meant to provide an adhesion function for sheet-to-sheet bonding, if needed. Note however that if this adhesion function is not needed, then the bond coating may be omitted from the 2-stage process described above. The materials for the bond coating may be polyvinylbutyral, polyester, polyamide, or epoxy and where the highest performing ones of such materials are designed to be thermosetting (so that they do not soften at elevated temperatures.)

There are at least two types of coil “winding methods” to form the coil (or create its windings) using the 2-stage, bond coating over base coating, approach. In solvent bonding, also known as “wet winding”, a solvent such as alcohol is used to activate the bond coating so as to provide the adhesion function between adjacent turns of the coil, and then the activated bond coating is cured or hardens (which may occur without the need to apply heat.) In hot air bonding, no solvent is needed, and instead hot air (in the range of for example 300-400 degrees Centigrade) is applied to soften the bond coating in order to provide the desired adhesion function.

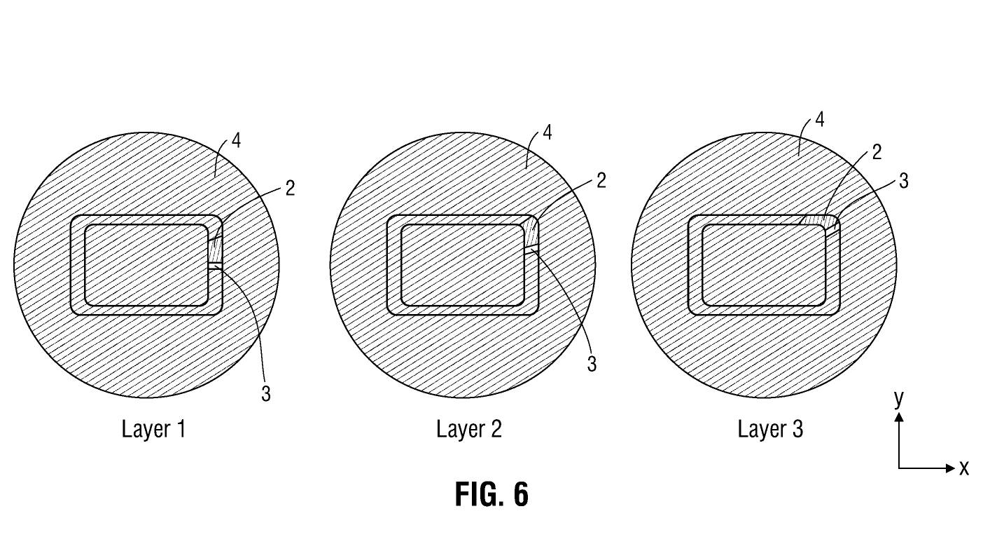

Referring back to FIG. 5, each laminated region includes a respective, flat conductor 2 in which a respective conductor gap 3 is formed that extends inward from an outer perimeter of the respective, flat conductor, and from a bottom face to a top face of the respective, flat conductor 2. Note that although FIG. 5 shows each laminated region as having a central opening, this is not required in all cases, because the subsequent operation of cutting out a separate electromagnet structure from a stack of the sheets of FIG. 5 (see FIG. 6) leads directly to the desired shape of the coil (regardless of whether or not a central opening is provided in the laminated region.) Each laminated region also includes a respective, flat insulator 4 in which a respective insulator gap 5 is formed that extends from a bottom face to a top face of the respective, flat insulator 4, resulting in a portion of the respective conductor 2 below it to be exposed (as shown in FIG. 5.)

In one aspect, each sheet can be created as a separate flexible printed circuit (FPC), using modified versions of FPC process operations. In one aspect, printed flex circuit technology may be used to form each turn of the coil, by forming a laminate of an insulator layer on top of a conductor layer, e.g., a laminate of polyimide on copper, which has been covered with a thermosetting adhesive or resin layer, and then etching the insulator layer on one side to form the insulator gap 5 therein (which may be the only location in the insulator layer where the top face of the conductor layer is exposed), and etching on the opposite side the conductor layer to form the conductor gap 3 therein.

Once all of the constituent turns of a coil design have been produced as laminated regions (in separate sheets, respectively), the sheets are stacked such that the individual laminated regions in each sheet are aligned with those in all of the other sheets, in the correct order (see, e.g., FIG. 3 showing the order of turns 9a, 9b, 9c, etc.) The stack may be placed into a heated press, and then cured at once via simultaneous resistive heating or externally applied heat source (if heating is needed for the particular method chosen to join the layers.) The stacking of the sheets of FIG. 5 results in the conductors 2 being interleaved with the insulators 4 for each instance of the coil.

Referring back to FIG. 4, the process then continues with pressing a top and a bottom of the stack of sheets towards each other while heating the stack until the respective insulator 4 in each sheet melts to form a bond with the bottom face of the respective conductor 2 of the sheet immediately above it. In addition, during the pressing, the bottom face of the respective conductor 2 in each sheet forms an electrical joint with the top face of the respective conductor 2 in the sheet that is immediately below it, through the gap in the respective insulator 4 of the sheet below. The stack is then allowed to cool so the bonds can cure and become stronger. Note that no fastener is needed to fuse the layers of the stack together. In the case of a heat-based fusion method, the temperature range of the insulating layer (acting as an adhesive layer) may be chosen to be high enough that the temperature required to activate it is outside the expected operating temperature range of the finished coil (in the case of a thermoplastic material). That way, the coil would retain structural integrity at the expected (lower) safe operating temperature it is designed for.

Heating the stack may involve sourcing an electrical current (from a source of electrical current) through the flat conductors 2, while pressing to also enable electrical contact between adjacent turns, which are coupled in series with each other. The current through all of the turns causes resistive heating of the conductors 2, until the insulators 4 become softened or melted to the point that they function as an interlayer bond. While doing so, the conductor 2 in each sheet could be also heated sufficiently so as to form its respective electrical joint with the conductor 2 that is immediately below it. In one aspect, this electrical joint is formed through the respective bridge region 7, in each sheet, which is on the top face of the respective, flat conductor 2 and is aligned with the insulator gap 5 that is formed in the respective, flat insulator 4 of the same sheet. In that case, the bottom face of the respective, flat conductor in each sheet becomes joined to the top face of the respective, flat conductor of the sheet below, through the respective bridge region of the sheet below melting in response to the heating. Note how in this aspect, there is no need to individually solder or weld the adjacent conductors 2, since their electrical joints may be formed contemporaneously due to the heating created by the electrical current that is being sourced through the series coupled conductors.

In one aspect, when using FPC techniques, the heating may cause the polyimide layer or resin layer (in each sheet or turn) to soften or melt and become sticky so as to form the bond (once it has cooled); in another aspect, each sheet or turn has only a single thermosetting polymer layer on its respective conductive layer, which softens or melts to fuse. In other aspects, the softening or melting is achieved by ultrasonic welding to fuse the insulator layer with the conductor layer that is immediately above it.

Once the bonds in the stack of sheets have cured, the process continues with cutting through the stack of sheets along a predetermined outer perimeter and along a predetermined inner perimeter of each of the laminated regions—see FIG. 6, which shows a rectangular inner perimeter and a rectangular outer perimeter. Cutting may be by laser cutting or by stamping or die cutting. This completes a number of separate annular structures (coils), respectively, wherein the respective conductor gaps 3 that are formed in their respective, flat conductors 2 now extend from the predetermined outer perimeter to the predetermined inner perimeter (in each of the separate annular structures.) Of course, as suggested above, the final shape of the coil may be different than shown in FIG. 6, e.g., it may be round, racetrack, zig zag, etc.

A method for manufacturing a coil has the following operations: arranging a plurality of sheets into a stack of sheets, each sheet having a region in which there is i) a respective, flat conductor in which a respective conductor gap is formed that extends inward from an outer perimeter of the respective, flat conductor, and from a bottom face to a top face of the respective, flat conductor, or ii) a respective, flat insulator in which a respective insulator gap is formed that extends from a bottom face to a top face of the respective, flat insulator, so that a number of flat conductors are interleaved with a number of flat insulators; and pressing a top and a bottom of the stack of sheets towards each other until the respective flat insulator in each sheet forms a bond with the bottom face of the respective conductor of the sheet above, and wherein the bottom face of the respective conductor in each sheet forms an electrical joint with the top face of the respective conductor in the sheet below through the gap in the respective insulator of the sheet below.

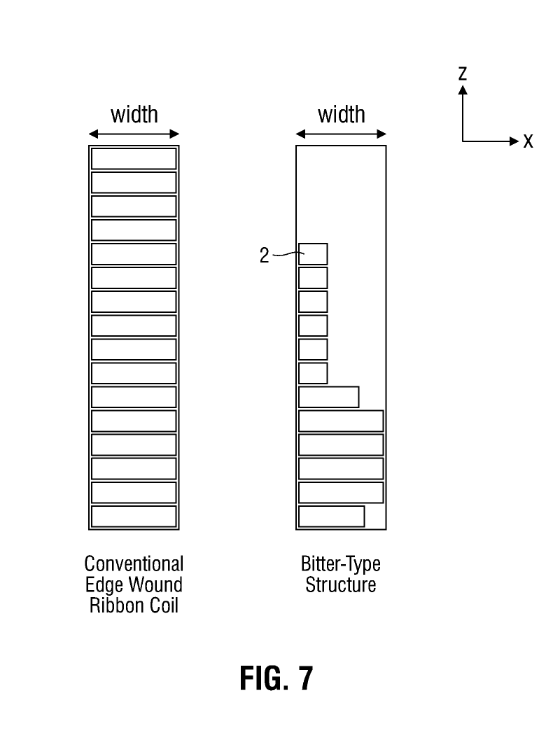

In one aspect, the respective, flat annular conductors in some of the turns of a coil have a narrower annular width than others (of the same coil.) This is depicted in FIG. 7, showing section views (taken along lines A-A′ shown in FIG. 1), where a conventional edge wound ribbon coil is shown that has uniform width due to the use of pre-flattened wire which generally is made with uniform dimensions along the entire roll of wire. The example shaped or profiled coil structure that is shown not only has non-uniform width in the conductor 2 of its lower most turns, but its top most “turns” are devoid of the conductor 2. Since the coil can be built layer by layer (or sheet by sheet, as in FIG. 5), its constituent conductors 2 can be positioned or shaped (height-wise as well as width-wise) where needed, in order to for example tailor the resulting force vs. excursion characteristic of the transducer or actuator of which it is a part. This also enables the materials selected for the different turns to be different, e.g., the conductor 2 of the bottom turn may be selected for structural strength or robustness, while the conductor 2 of the middle turns are elected for superior electrical and physical properties, e.g., pure copper, aluminum, silver, or another conductive alloy, and the conductor 2 of the top turn is selected for superior fatigue life, e.g., beryllium-copper or high tension copper.

Another benefit of being able to change the conductor material used per layer is a newfound ability to adjust the resistivity of the current path as a function of the elevation of the turn within the coil. One benefit of this, for example, is the possibility of tailoring the resistance such that power is preferentially dissipated in one section of the coil (such as towards the central turns) rather than at the uppermost or lowermost turns, which could help to increase the total power handling capability of a coil design.

In one aspect, building a coil up in an additive, layer-by-layer process as described here allows the deposition of the conductors only where desired. For example, in the right side image of FIG. 7, the topmost five conductive layers may be arranged so that the current flows in a straight line from top to bottom along a low resistance path (without circulation) until it reaches the sixth layer from the top, where the current is forced to circulate in a spiral pattern through the remaining layers until reaching the bottom.

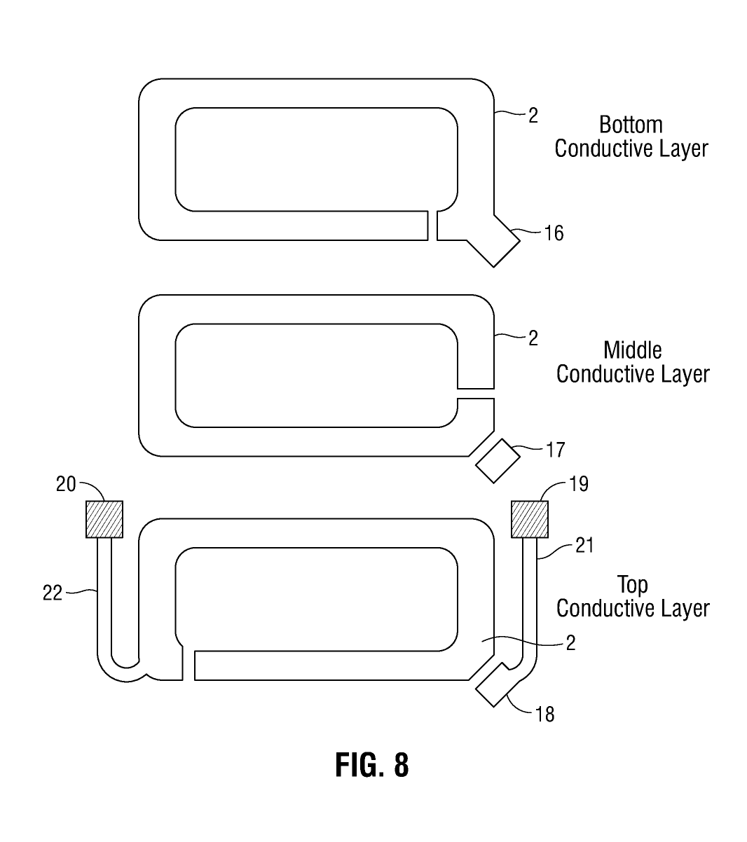

Turning now to FIG. 8, this figure shows an example of the bottom, middle and top conductors 2 of the electromagnet structure, and how the electrical terminals of the coil or electromagnet can be positioned in the same layer as the top conductor 2. A first electrical terminal 20 (that is to conduct the coil current), is formed in the same layer as the conductor 2 of the top turn, and is joined to the flat annular conductor 2 in the top most turn through a lead trace 22 that is also formed in the same conductive layer. A second electrical terminal 19 (that is to also conduct the coil current) is also formed in the same layer of the conductor 2 of the top most turn and is electrically joined to one end of a lead trace 21, in the same layer. The other end of the lead trace 21 is a pad 18 (in the same layer) that is part of an electrical connection that extends downward to and joins the flat annular conductor 2 in the bottom most turn, through a column of pads 17 in the middle turns that are aligned with a tab or ear 16 of the conductor 2 in the bottom turn, as shown. This connection may be a plated through hole via, or it may be composed of stacked conductive layers, electrically unconnected to the main coil trace (conductors 2) except at the bottom layer, which are vertically aligned such that in the aggregate the stack may conduct current in a vertical path in a substantially straight line from pad 16 to pad 18. The addition of the lead traces 21, 22 may enable easier soldering or welding to the terminals 20, 19, especially protecting the multi-layer FPC structure against excessive heat from the soldering or welding operation. It also functions as a flexible electrical joint, which would be useful for moving coil applications such as loudspeakers or shakers where a method to electrically connect the moving coil to a stationary contact is needed. Lead traces 21, 22 may be replicated in one or more middle conductive layers, while being electrically isolated from the flat annular conductor. This would serve to mechanically thicken and reinforce the lead trace.

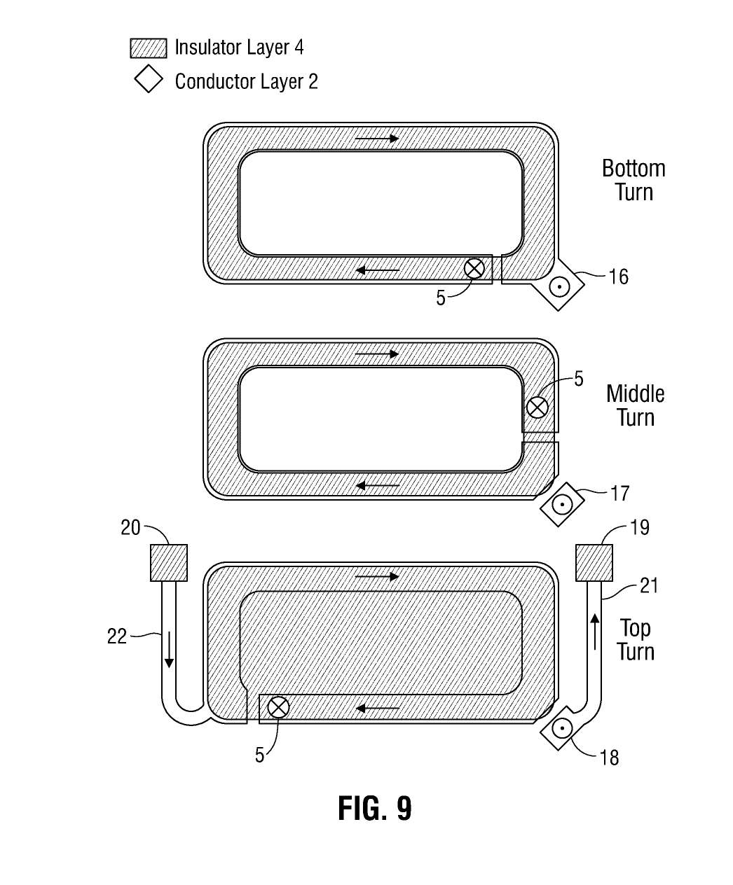

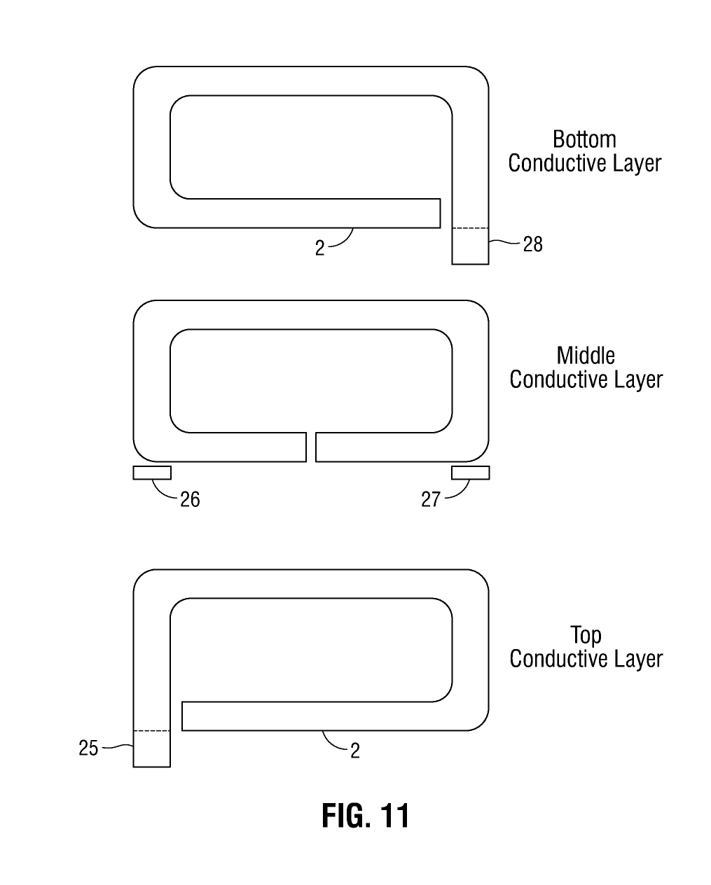

Turning now to FIG. 11, this figure shows an alternative coil termination scenario that may mitigate the impact of externally applied heat that is needed to solder or weld a separate wire onto a terminal of the coil structure (e.g., terminals 19, 20 shown in FIG. 9.) To explain the problem, when a wire, or other electrical connection, is connected to such a terminal by introducing heat directly into the laminate stack of conductors 2, it is possible that the heat needed to flow such solder, or form a microweld between for example copper and tin, can quickly spread into the body of the coil structure and thereby sufficiently melt one or more of the insulator layers (insulators 4) which causes several conductors 2 of the coil structure to become electrically shorted. To mitigate this, FIG. 11 shows a scenario where an extension 25 is formed in the top conductor layer (conductor 2), and an extension 28 is formed in the bottom conductor layer (conductor 2), which serve as the electrical terminals of the coil structure. Also, associated pads 26, 27 are formed which together serve as a thermal transfer, to move the application of the heat, for connecting the wire or other electrical connection described above, away from the main body of the coil.

For the extension 25, one or more electrically isolated pads 26 are formed in one or more middle conductive layers, respectively, as shown, that are aligned vertically below the extension 25. Similarly, for the extension 28, there are one or more electrically isolated pads 27 formed in the one or more middle conductive layers, respectively, as shown. Each of pads 26, 27 is spaced apart from its respective trace (conductor 2) to provide the needed electrical isolation from the trace of the conductor 2, as shown. The extension 25 may be folded downward along the dotted line shown, and then adhered to the side of the coil structure in contact with its respective group of vertically aligned pads 26, with an electrically isolating adhesive (after the coil structure has been separated from the sheet laminate.) Similarly, the extension 28 may be folded upward along the dotted line shown, and then adhered to the side of the coil structure in contact with its respective group of vertically aligned pads 27, with an electrically isolating adhesive (after the coil structure has been separated from the sheet laminate.) In that condition, each group of vertically aligned pads 26, 27 serves to mechanically reinforce each other, and serve as a heatsink to draw heat away from the body of the coil, when for example a wire is being soldered or welded to the respective extension 25, 28.

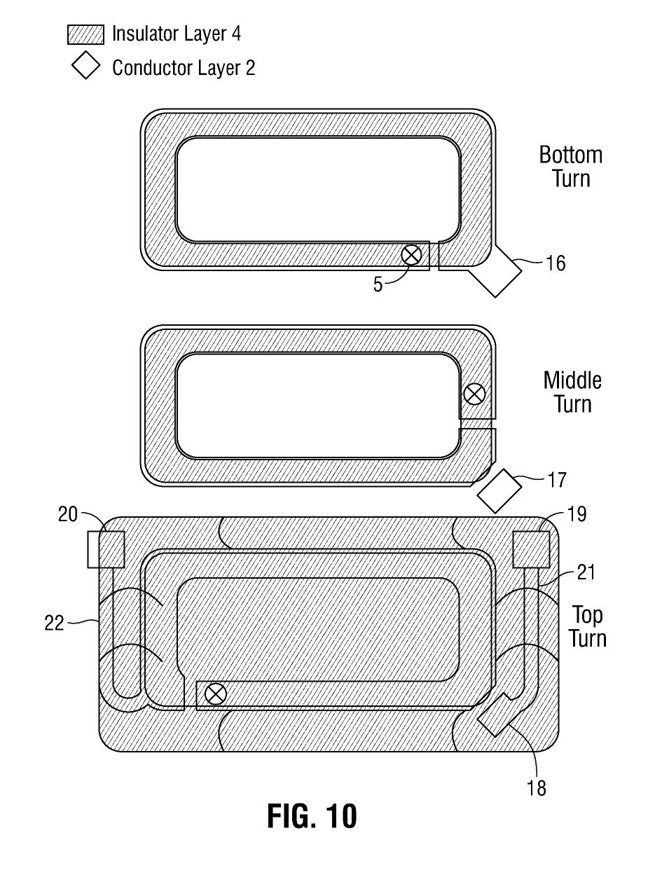

As was suggested above, one of the applications of the electromagnet structure or coil described here is as part of an acoustic output transducer motor or driver. FIG. 9 shows such an application, where a diaphragm is attached to the top of the top most turn, completely covering the central opening of the electromagnet structure's stack of turns below it. The diaphragm may be made of the same material and thickness as the insulator 4, or it may be made thicker, or of a different material altogether. A further level of integration may be reached for such an acoustic transducer, by creating a suspension from the same or similar material as the insulator 4 that is the top insulator layer (on top of which there may or may not be any conductive traces) of the coil, as shown in FIG. 10. Note that although not shown, there is a magnetic gap (air gap) in the magnet system of the acoustic output transducer, behind the diaphragm, within which the coil structure is suspended. Other applications of the coil or electromagnet structure include electric motors in fans and in haptic devices.

Returning to FIG. 2a, it can be seen that in each turn or layer of the coil structure, the respective, flat annular conductor 2 forms a single conductive loop but for the respective conductor gap 3 which extends from an outer perimeter to an inner perimeter of the single loop-type, conductor 2 (thereby breaking the loop.) By contrast, in the aspect of FIG. 12, in each turn, the respective, flat annular conductor 2 forms a spiral of two or more loops; in other words, the conductor 2 defines multiple loops in a single conductor layer (as part of a single “turn.”) The electrical joint between two adjacent ones of the conductors 2 (conductor layers) is still formed through the insulator gap 5 that is formed in the insulator 4 (insulating layer) that electrically isolates the two adjacent conductors 2 from each other. The rest of the techniques described above in connection with the single loop structure of the conductor 2 in general also apply to a coil structure whose individual conductor layers (conductors 2) have a multi-loop spiral structure such as shown in FIG. 12. Note here that although the gradually tightening (or widening) elongated conductor shown in that figure is an Archimedes spiral that has generally circular loops which are evenly spaced and terminate at the center, the spiral structure could have any other shape, such as rectangular (or more generally composed of line segments), with non-uniform spacing between adjacent loops, and/or not terminating at the center.

Another aspect of the disclosure here is a method for manufacturing a multilayer planar coil, the method comprising: producing a printed circuit laminate having a plurality of conductor layers interleaved with a plurality of insulator layers, wherein each conductor layer has patterned therein one or more conductive loops; and forming a plurality of vias in the printed circuit laminate, and wherein the one or more conductive loops in each adjacent pair of the conductor layers are electrically joined to each other through a respective one of the vias, to complete a plurality of constituent turns of a coil.

While certain aspects have been described and shown in the accompanying drawings, it is to be understood that such are merely illustrative of and not restrictive on the broad invention, and that the invention is not limited to the specific constructions and arrangements shown and described, since various other modifications may occur to those of ordinary skill in the art. For example, while the drawings depict the conductor 2 and insulator 4 of each turn 9 in FIGS. 2a and 2b as disks or round, flat rings, an alternative is to create those components in other shapes such as squares or rectangles. Also, while several electromagnet structure manufacturing processes have been described above with each having a particular sequence of operations as examples, some of those operations may occur out of sequence. In other instances one or more operations or materials from one process may be combined with or substituted into those of another process, to yield an electromagnet structure that is similar to those described above. The description is thus to be regarded as illustrative instead of limiting.

What is claimed is:

1. A coil structure comprising:
a plurality of turns, each turn having
i) a respective, flat annular conductor having a bottom face and a top face, and
ii) a respective, flat annular insulator in which a respective insulator gap is formed that extends from a bottom face to a top face of the insulator,
iii) wherein the bottom face of the respective insulator is bonded to the top face of the respective conductor,
and wherein the plurality of turns are stacked or form a stack, so that a plurality of flat annular conductors are interleaved with a plurality of flat annular insulators,
wherein the top face of the respective flat annular insulator of each turn forms a bond with the bottom face of the respective conductor of the turn above, and the bottom face of the respective annular conductor of each turn is electrically joined to the top face of the respective annular conductor of the turn below through the insulator gap in the respective annular insulator of the turn below.

2. The coil structure of claim 1 wherein the respective flat annular insulator of each turn comprises a thermosetting polymer that has melted to form the bond.

3. The coil structure of claim 1 wherein the respective flat annular insulator of each turn comprises a coating that was applied in a liquid state onto the respective flat annular conductor and that hardened to form the respective flat annular insulator.

4. The coil structure of claim 1 wherein the respective flat annular insulator comprises a polymer layer and a bonding layer.

5. The coil structure of claim 4 wherein the polymer layer comprises a cured polyimide and the bonding layer comprises an epoxy-based adhesive.

6. The coil structure of claim 1 further comprising:
a first electrical terminal to conduct electrical current, formed in the top most turn and joined to the flat annular conductor in the top most turn; and
a second electrical terminal to conduct the electrical current, formed in the top most turn and electrically joined through a connection that extends downward to and joins the flat annular conductor in the bottom most turn.

7. The coil structure of claim 1 wherein each turn is produced as a separate piece, before being bonded to another turn, as part of the stack.

8. The coil structure of claim 1 wherein in each turn, the respective, flat annular conductor forms a single loop but for a respective conductor gap that extends from an outer perimeter to an inner perimeter of the conductor, and wherein a position of the respective conductor gap in each turn, as projected onto a horizontal plane along a vertical axis that runs through the respective conductor gap, is offset relative to the position of the respective conductor gap in an adjacent turn.

9. The coil structure of claim 1 wherein in each turn, the respective, flat annular conductor forms a spiral that has a plurality of loops.

10. The coil structure of claim 1 wherein the respective, flat annular conductors in some of the plurality of turns have a narrower annular width than others.

11. The coil structure of claim 1 further comprising a diaphragm attached to a top most turn and that completely covers the stack.

12. The coil structure of claim 1 further comprising
a respective bridge region in each turn, wherein the respective bridge region is joined to the top face of the respective, flat annular conductor and is aligned with the insulator gap that is formed in the respective, flat annular insulator of the turn,
wherein the bottom face of the respective annular conductor of each turn is electrically joined to the top face of the respective annular conductor of the turn below through the respective bridge region of the turn below.

13. The coil structure of claim 12 wherein the respective bridge region comprises a plurality of conductive microspheres.

14. A method for manufacturing a coil structure, the method comprising:
arranging a plurality of sheets into a stack of sheets, each sheet having a laminated region that comprises
i) a respective, flat conductor, and
ii) a respective, flat insulator in which a respective insulator gap is formed that extends from a bottom face to a top face of the respective, flat insulator,
so that a plurality of flat conductors are interleaved with a plurality of flat insulators; and
pressing a top and a bottom of the stack of sheets towards each other while heating the stack until the respective flat insulator in each sheet forms a bond with the bottom face of the respective conductor of the sheet above,
and wherein the bottom face of the respective conductor in each sheet forms an electrical joint with the top face of the respective conductor in the sheet below through the gap in the respective insulator of the sheet below.

15. The method of claim 14 wherein heating the stack comprises sourcing an electrical current through the plurality of flat conductors, which are coupled in series with each other, to resistively heat the plurality of flat conductors until the plurality of flat insulators bond to their adjacent flat conductors.

16. The method of claim 15 further comprising
creating a respective bridge region in each sheet, on the top face of the respective, flat conductor and is aligned with the gap that is formed in the respective, flat insulator of the sheet,
wherein the bottom face of the respective, flat conductor in each sheet is joined to the top face of the respective, flat conductor of the sheet below, through the respective bridge region of the sheet below.

17. The method of claim 14 further comprising
creating a respective bridge region in each sheet, that is joined to the top face of the respective, flat conductor and is aligned with the gap that is formed in the respective, flat insulator of the adjacent sheet,
wherein the bottom face of the respective conductor is joined to the top face of the respective conductor of the sheet below through the respective bridge region of the sheet below.

18. The method of claim 17 wherein heating the stack comprises sourcing an electrical current through the plurality of flat conductors, which are coupled in series with each other, to resistively heat the plurality of flat conductors until the respective bridge region softens or melts.

19. The method of claim 14 wherein each sheet has formed therein a plurality of laminated regions each region having a conductor or an insulator, wherein the regions are replicates, the method further comprising
cutting through the stack of sheets along a predetermined outer perimeter and along a predetermined inner perimeter of each of plurality of laminated regions, to result in a plurality of separate annular structures, respectively, wherein a respective conductor gap is formed in the respective, flat conductor extends from the predetermined outer perimeter to the predetermined inner perimeter in each of the plurality of separately annular structures.

20. A multilayer circuit structure comprising:
a plurality of electrically conductive trace layers, separated from each other by a plurality of electrically insulating layers wherein
i) the thickness of any given one of the conductive trace layers is greater than the thickness of an adjacent one of the insulating layers, and
ii) each of the conductive trace layers is bonded to an adjacent one of the insulating layers, and is electrically connected to an adjacent one of the conductive trace layers through a gap in said adjacent one of the insulating layers that is between them.

21. The multilayer circuit structure of claim 20 wherein the thickness of each of the insulating layers is less than 20 microns.

22. The multilayer circuit structure of claim 20 further comprising a plurality of bridge regions wherein each bridge region is formed in the gap in said adjacent one of the insulator layers that is between a respective pair of adjacent conductive trace layers.

23. The multilayer circuit structure of claim 22 wherein each bridge region comprises a printed circuit via being one of a plated via or a plug of a conductive material.
